(19) United States
(12) Patent Application Publication
(10) Pub. No.: US 2014/0365346 A1
(43) Pub. Date: Dec. 11, 2014

(54) METHOD OF VERIFYING A DEBT

(71) Applicants: Cole Whitcher, Brea, CA (US); Wayne Swanson, Brea, CA (US)

(72) Inventors: Cole Whitcher, Brea, CA (US); Wayne Swanson, Brea, CA (US)

(21) Appl. No.: 13/910,744

(22) Filed: Jun. 5, 2013

(51) Int. Cl. G06Q 40/00

(52) U.S. Cl. CPC G06Q 40/12
USPC 705/30

(57) ABSTRACT

A method of verifying a debt and ownership of the debt including the steps of providing a Debt System in which information on debts, the person/organization who owes each of the debts, and the person/organization who owns each of the debts are registered, registering in the Debt System a debtor that owes one of the registered debts, registering in the Debt System a person/organization debt owner that owns the one of the registered debts, and the Debt System providing to the debtor that owes one of the registered debts information on the one of the registered debts in response to a request to the Debt System, the information including the person/organization who owns the one of the registered debts.

### FIELD OF THE INVENTION

This invention generally relates to a method of confirming a debt is valid and who owns the debt or is a legitimate collector for the debt owner.

### BACKGROUND OF THE INVENTION

A current challenge in the debt collection industry is fraud and illegal collection practices, e.g. people posing as collectors for the purpose of defrauding a debtor. Currently there are few tools available for the debtor to prevent or defend against such activity. The best the debtor can do is be diligent to make anyone attempting to collect a debt prove the debt is real and confirm their identity. Unfortunately, debtors do not have the information or knowledge on how to best do this and end up being tricked even when they are attempting to protect themselves. Another mechanism debtors use is by sharing information on websites and forums that specialize in debt collection tracking. The down side of this mechanism is the reliability of the information being shared as it is based on debtors sharing what they have experienced and can vary from person to person. There is no way to be sure as to the validity of each post.

The challenge faced by debt collectors is the debtor not believing them when they make contact. This delays any collection process if the debtor rejects the collectors claim and the collector has no simple way to confirm the debt is real and legitimate that the debtor will accept.

It would be highly advantageous, therefore, to remedy the foregoing and other deficiencies inherent in the prior art.

Accordingly, it is an object of the present invention to provide a new and improved process for confirming the ownership of a debt and that the debt is valid.

It is another object of the present invention to provide a new and improved process for confirming the ownership of a debt and that the debt is valid which is available to both the debtor and the collector/owner.

### SUMMARY OF THE INVENTION

The desired objects and purposes of the instant invention are achieved in accordance with a method of verifying a debt and ownership of the debt including the steps of providing a Debt System in which information on debts, the person/organization who owes each of the debts, and the person/organization who owns each of the debts are registered, registering in the Debt System a debtor that owes one of the registered debts, registering in the Debt System a person/organization debt owner that owns the one of the registered debts, and the Debt System providing to the debtor that owes one of the registered debts information on the one of the registered debts in response to a request to the Debt System, the information including the person/organization who owns the one of the registered debts.

The desired objects and purposes of the instant invention are further achieved in accordance with a Debt System designed to verify a debt and ownership of the debt for the benefit of a debtor and a debt owner. The Debt System including a Debt System repository in which information on debts, including the person/organization who owes each of the debts and the person/organization who owns each of the debts, are registered and stored. The Debt System repository includes a debtor registration portion for registering debtors that owe one of the registered debts and a debt owner registration portion for registering debt owners that own at least one of the registered debts. The Debt System also includes interactive hardware, providing to the debtor that owes one of the registered debts, information on the one of the registered debts. The information is provided in response to a request to the Debt System, the information including the person/organization who owns the one of the registered debts.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 illustrates diagrammatically the various functions or steps performed by debtors, collectors, and the system in accordance with the present invention;

FIG. 2 is a flow chart illustrating the “load sold accounts” file as performed by the collector in FIG. 1;

FIG. 3 is a flow chart illustrating the “check portfolio for duplicates/crossover” step as performed by the collector in FIG. 1;

FIG. 4 is a flow chart illustrating the “process notifications for new debt accounts” step as performed by the system in FIG. 1; and

FIG. 5 is a flow chart illustrating the “signup for new debt notifications” step as performed by the debtor in FIG. 1.

### DETAILED DESCRIPTION OF THE DRAWINGS

The present invention is a method of confirming the ownership and validity of a debt and solves the issues and failings of the prior art by acquiring the data necessary to make definitive determinations as to whether a debt is valid and by whom it is owned. The method is preferably performed by a third party which aids the third party in voluntarily acquiring, sharing, and objectively validating information related to specific accounts, persons, portfolio/account acquisition transactions, and debt owners. The third party can enable a collector/debt owner to quickly share with the debtor a way to reliably confirm the debt is theirs and the collector for the debt owner is not attempting to defraud them. The debtor is also able to find other debts they are liable for and may not be aware are not owned and being collected on by other parties. The present system and method adds legitimacy to participating collectors/debt owners and gives a sense of security to debtors. With these major purposes in mind the various drawings are described in detail below.

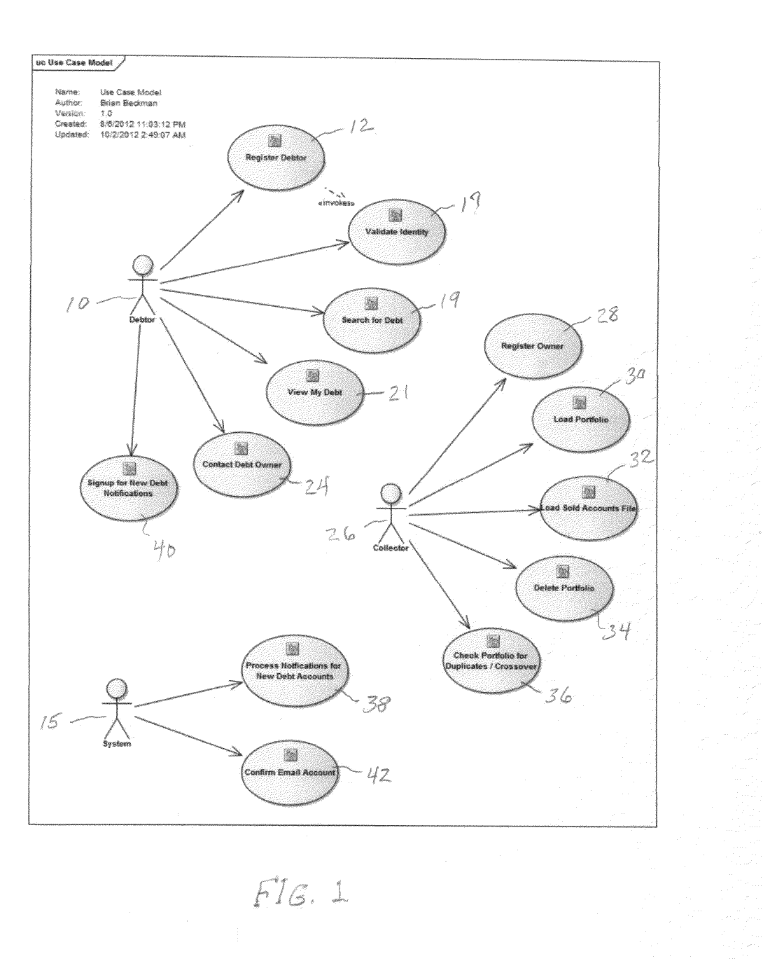

Referring specifically to FIG. 1, a debtor designated 10 is illustrated. As a first step, designated 12, debtor 10 registers with the Debt System, designated 15, and illustrated diagrammatically in the lower left hand corner of FIG. 1. As stated above, the major purpose of debtor 10 registering with Debt System 15 is to make definitive determinations as to whether a debt is valid and by whom it is owned. Here it should be understood that a debtor may register in system 15 even if they do not have a debt registered in system 15 as this enables them to be notified if in the future any debt owner or collection agency adds a debt to system 15 that the debtor does not owe. A step 17 performed during or in conjunction with registration is for the debtor to validate their identity, which validation may be used at any time the debtor is contacted or contacts another party, such as a debt collector/owner or Debt System 15.

After registration and identity validation, debtor 10 may search the system files, step 19, for any debts he may have and which are in the system files. When the debt is found in the files of Debt System 15 it is essentially confirmed or validated by Debt System 15. The debtor can then view the debt, step 21, for further confirmation of the validity and for information as to the owner of the debt. Once debtor 10 has established who the owner of the debt is through the files of Debt System 15, debtor 10 can contact the owner, step 24, for any additional information that may be desired.

In a similar fashion, a debt owner/collector designated 26 is illustrated diagrammatically in the right hand portion of FIG. 1. It will be understood that the debt owner has access to the system, and can act as a collector. However, many debt owners have agents acting as collectors who actually perform the collecting of debts. In either instance, the debt owner has access to the system, and the collector has access through the debt owner. Therefore, debt owner and collector will be treated as synonymous for purposes of this description. As a first step, designated 28, debt owner/collector 26 registers the owner of any debts they may have listed in the files of Debt System 15. Again, here it should be understood that debt owner/collector 26 will generally be the owner of the debt or a representative registered as the “owner's representative” and such information will be on file in conjunction with each debt on file. As a second step, designated 30, the collector/owner 26 will load a portfolio for each debt they own, which portfolio will include all of the information relative to the associated debt. The portfolio loaded into Debt System 15 contains the information available to debtor 10 when viewing the file in step 21.

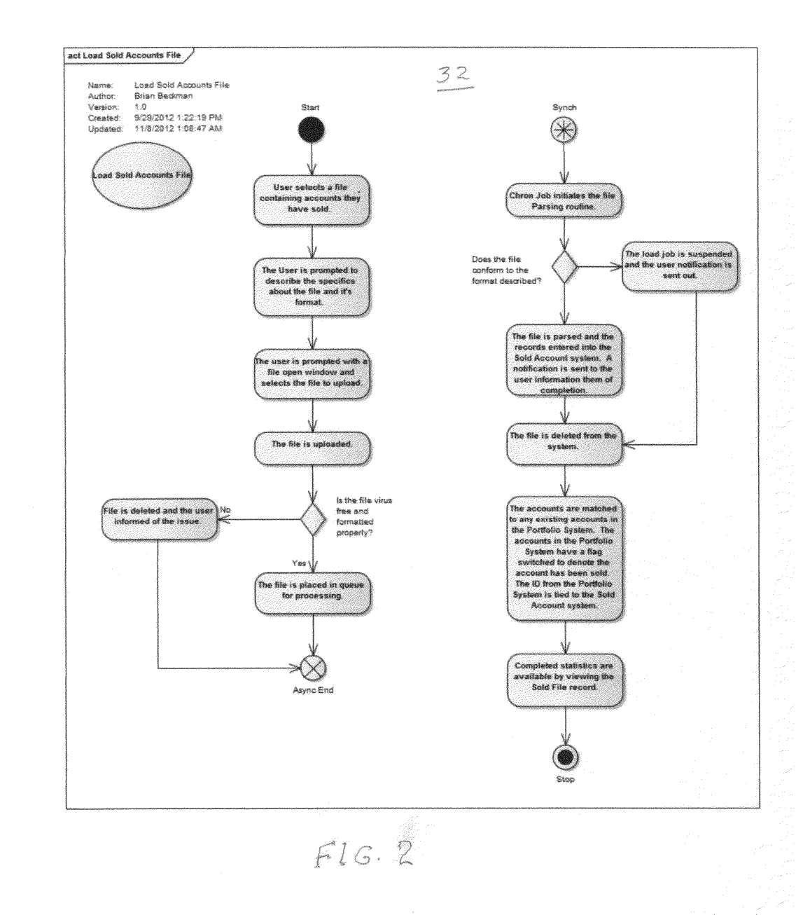

In addition to loading all of the debt portfolios into Debt System 15, as an ongoing upgrade step or process collector/owner 26 provides a file of “sold accounts” that are loaded into Debt System 15 in a step-process 32. The “sold accounts” file is continuously upgraded in accordance with a flow chart illustrated in FIG. 2. As illustrated in the flow chart of FIG. 2, collector/owner 26 starts step-process 32 by selecting a file containing accounts they have sold. Debt System 15 prompts collector/owner 26 to describe the specifics about the file and its format. After inputting the information about the file, Debt System 15 prompts collector/owner 26 with an open window to select the file to be uploaded.

When the proper file is selected it is uploaded and checked for virus and to ensure that it is formatted properly. If a virus is present or the formatting is improper the file is deleted and collector/owner 26 is notified. If no virus is present and the formatting is proper the file is placed in a queue for further processing. This is referred to as the end of the asynchronous portion of step-process 32 and when the file is reached in the queue the synchronous portion of step-process 32 begins, that is the file parsing routine is initiated.

Initially Debt System 15 checks the file to determine whether the file conforms to the format described. If not, the loading is suspended and collector/owner 26 is notified. If the file format conforms to the description, the file is parsed, the records entered into the Sold Accounts portion of Debt System 15, and collector/owner 26 is notified of the completion. With the collector/owner notification the file is deleted from Debt System 15. With the deletion of the file, the accounts are matched to any existing accounts in the portfolio portion of Debt System 15, and a flag is switched to any matching accounts to denote the account has been sold. Also, the ID from the portfolio portion of Debt System 15 is tied to the sold accounts portion. The completed statistics are available to user collectors and user debtors by viewing the sold accounts record. The portfolio for the sold account file is deleted from the portfolio portion of Debt System 15 and is also deleted by collector/owner 26 in a step designated 34 in FIG. 1.

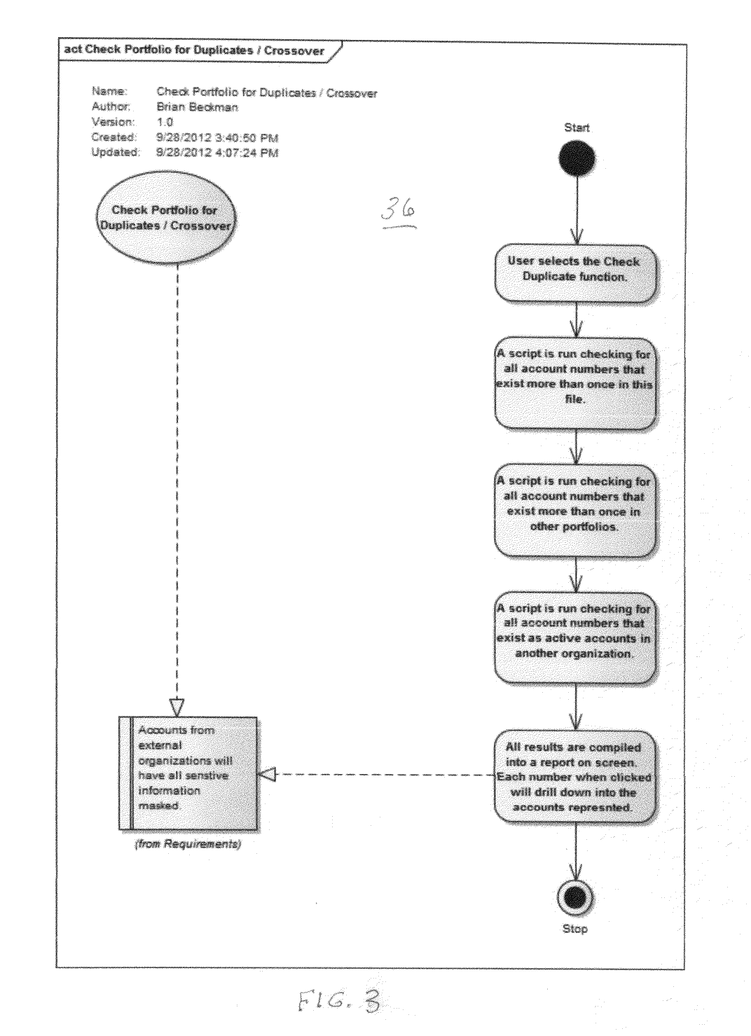

Another step-process that can be performed by collector/owner 26 is to check the portfolio for duplicates or crossovers, designated 36 in FIG. 1. Step-process 36 for checking the portfolio for duplicates/crossover is illustrated in detail in FIG. 3. Initially collector/owner 26 goes to Debt System 15 and selects the Check Duplicate Function. A script is run by Debt System 15 checking for all account numbers that exist more than once in the portfolio file being checked. Another script is run by Debt System 15 checking for all account numbers that exist more than once in other portfolios. Also, another script is run by Debt System 15 checking for all account numbers that exist as active accounts in another organization. All results from the three scripts are compiled into a report on screen and collector/owner 26 can view details of the accounts by clicking on the number on the screen. It should be noted that accounts from external organizations will have all sensitive information masked.

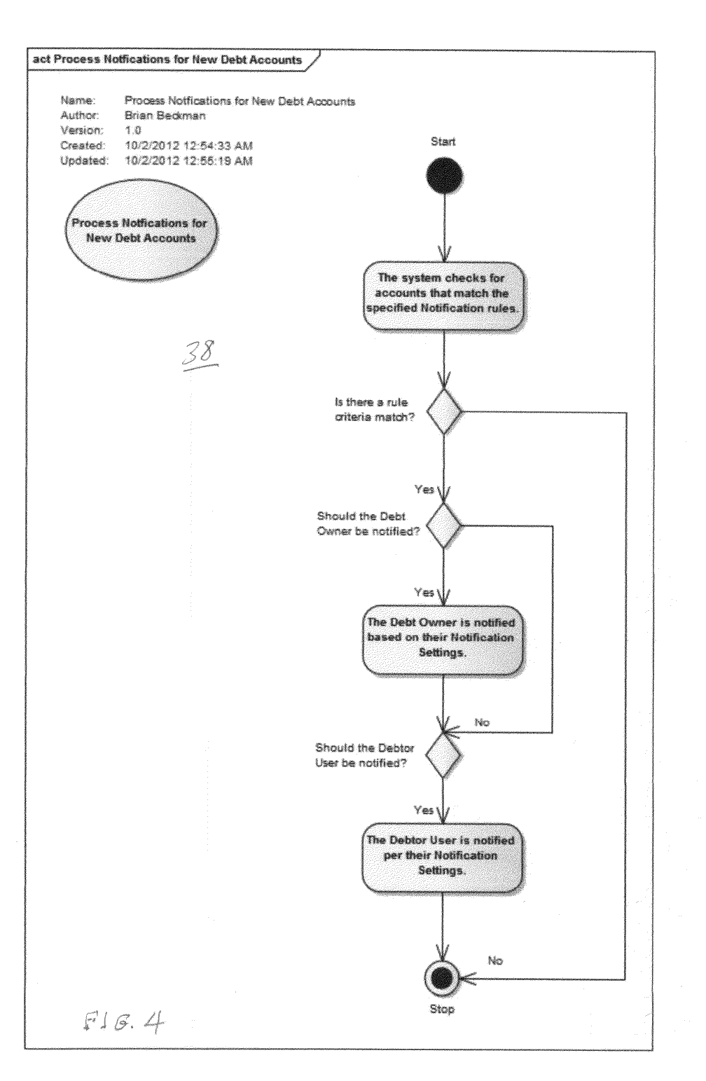

One of the major functions of Debt System 15 is to process notifications for new debt accounts, designated 38 in FIG. 1. Function 38 is described in detail in the flow chart illustrate in FIG. 4. When a new debt account is received by Debt System 15 function 38 is started by checking the new debt account for a match of specified notification rules. The notification rules include various information that identifies and validates the debt account, such as the debt owner, the debtor, and other information needed to properly process and load the new debt account into Debt System 15. If there is no rule criteria match function 38 is immediately stopped. If there is a rule criteria match function 38 moves to a decision as to whether the debt owner (e.g. collector/owner 26) should be notified or not. If the decision is yes the debt owner is notified based on predetermined notification settings of the debt owner. If the decision is no, or once the debt owner is notified, function 38 moves to a decision as to whether debtor 10 should be notified or not. If the decision is yes the debtor is notified based on predetermined notification settings of the debtor.

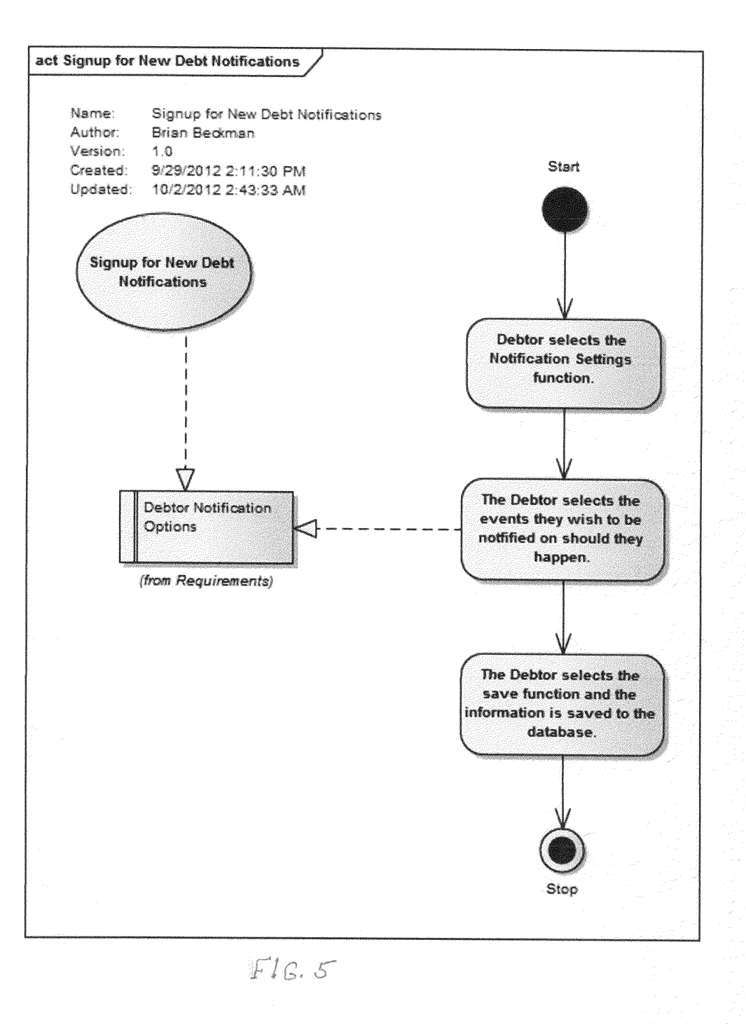

One option available to debtors that have registered with Debt System 15 is to sign up for new debt notifications. The new debt sign up registration is available at any time during the valid registration of a debtor. As an example, FIG. 1 illustrates the signup for new debt notification option, designated 40, for debtor 10. Option 40 is illustrated in detail by the flow chart of FIG. 5. In this example the option is started by debtor 10 selecting the notification settings function in Debt System 15. Once the function is selected debtor 10 selects the events they wish to be notified on should such events occur. The selected events can be preprogrammed questions that the debtor answers or simply information that the debtor inputs. After the events are selected the debtor selects the save function and the events information is saved to a database in Debt System 15. Thus, notification option 40 for debtor 10 (or any other registered debtor) corresponds with function 38 of Debt System 15. Debt System 15 also includes a function of confirming Email accounts, designated 42, for registered debtors and collector/owners so that all users can be conveniently notified or otherwise contacted.

It will be understood that the various registrations and validations can be accomplished through Email accounts so that the process is simple and convenient. Also, various triggers or notifications can be incorporated into system 15 so that, for example, debtor 10 can be automatically notified whenever his registered debt is changed for example sold to another creditor. Further, triggers or notifications can be incorporated into system 15 to provide collector/owner 26 with information, for example, a list of all debts he owns and the status of those debts.

It will be understood by those skilled in the art that the Debt System includes various repositories for the portfolios described above and to contain the various registrations and associated information. Also, interactive hardware, including search machines and the like, is associated with the repositories to allow for the various contacts, questions, additions and subtractions/deletions. Some or all of the triggers or notification (and others) can be included in the interactive hardware so as for example to appear automatically as an Email (when prearranged) for either debtor 10 and/or collector 26. The actual machinery or hardware is not disclosed in detail since the known functions are automatically included in the description of the process.

Thus, the present invention provides a new and improved process to allow collector/owners to quickly and easily share with debtors a way to reliably confirm that debts are valid and collectors are legitimate. The present invention provides a new and improved process to quickly and easily confirm the ownership of a debt and that the debt is valid. Because the debtors and collector/owners are registered with the novel third party Debt System, the validity and ownership of debts can quickly be checked by either party to ensure against fraud and misuse.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same,

The invention claimed is:

1. A method of verifying a debt and ownership of the debt comprising the steps of;
providing a Debt System in which information on debts, the person/organization who owes each of the debts, and the person/organization who owns each of the debts are registered;
registering in the Debt System a debtor that owes one of the registered debts;
registering in the Debt System a person/organization debt owner that owns the one of the registered debts; and
the Debt System providing to the debtor that owes one of the registered debts information on the one of the registered debts in response to a request to the Debt System, the information including the person/organization who owns the one of the registered debts.

2. The method as claimed in claim 1 including in addition the steps of registering in the Debt System a debt that has been sold and deleting from the Debt System the debt that has been sold.

3. The method as claimed in claim 1 including in addition a step of the Debt System checking the registration of information on debts for duplicate debt accounts.

4. The method as claimed in claim 3 wherein the step of the Debt System checking the registration of information on debts for duplicate debt accounts is performed by a person/organization debt owner.

5. The method as claimed in claim 1 including in addition a step of registering in the Debt System new debt accounts and making the new debt accounts available to registered debtors and debt owners of the new debt accounts.

6. A method of verifying a debt and ownership of the debt comprising the steps of;
providing a Debt System including at least one repository in which information/details on debts, the person/organization who owes each of the debts, and the person/organization who owns each of the debts are registered and interactive hardware accessible through the internet;
registering in the Debt System at least one debt and the person/organization debt owner that owns the at least one registered debt;
registering in the Debt System a debtor that owes the at least one registered debt;
receiving in the Debt System a request from one of the debtor that owes the at least one registered debt and the person/organization debt owner that owns the at least one registered debt for information on the at least one registered debt, the information including details about the at least one of the registered debt and the person/organization who owns the at least one of the registered debts; and
providing in response to the request information on the at least one of the registered debts.

7. The method as claimed in claim 6 including in addition the steps of registering in the Debt System a debt that has been sold and deleting from the Debt System the debt that has been sold.

8. The method as claimed in claim 6 including in addition a step of the Debt System checking the registration of information on debts for duplicate debt accounts.

9. The method as claimed in claim 8 wherein the step of the Debt System checking the registration of information on debts for duplicate debt accounts is performed by a person/organization debt owner.

10. The method as claimed in claim 6 including in addition a step of registering in the Debt System new debt accounts and making the new debt accounts available to registered debtors and debt owners of the new debt accounts.

11. A Debt System designed to verify a debt and ownership of the debt for the benefit of a debtor and a debt owner, the Debt System comprising;
a Debt System repository in which information on debts, including the person/organization who owes each of the debts and the person/organization who owns each of the debts, are registered and stored;
the Debt System repository including a debtor registration portion for registering debtors that owe one of the registered debts;
the Debt System repository including a debt owner registration portion for registering debt owners that own at least one of the registered debts; and
the Debt System including interactive hardware providing to the debtor that owes one of the registered debts information on the one of the registered debts in response to a request to the Debt System, the information including the person/organization who owns the one of the registered debts.
